(19) United States
(12) Patent Application Publication
(10) Pub. No.: US 2019/0293582 A1
(43) Pub. Date: Sep. 26, 2019

(54) APPARATUS FOR DETECTING MOISTURE BASED ON SIGNAL OUTPUTTED FROM HEAT FLOW SENSOR

(71) Applicant: DENSO WAVE INCORPORATED, Chita-gun (JP)

(72) Inventor: Kensuke NAKAJIMA, Chita-gun (JP)

(73) Assignee: DENSO WAVE INCORPORATED, Chita-gun (JP)

(21) Appl. No.: 16/359,862

(22) Filed: Mar. 20, 2019

(30) Foreign Application Priority Data
Mar. 20, 2018 (JP) 2018-052529

(51) Int. Cl. G01N 25/56; G01K 17/06; G01M 3/00

(52) U.S. Cl. CPC G01N 25/56; G01M 3/002; G01K 17/06

(57) ABSTRACT

A moisture detection apparatus is equipped with a case having a detection surface. The apparatus includes a heat flow sensor provided to be in contact with the detection surface, a heat source provided on a side facing the detection surface with the heat flow sensor therebetween, and a determining unit. The heat flow censer, the heat source, and the determining unit are housed in the case. The heat flow sensor is oriented to detect a flow of heat from the heat source towards the detection surface. The heat source generates heat at all times at an amount that enables the heat flow sensor to be in a thermally saturated state in a state where moisture is not attached to an outer side of the detection surface. The the determining unit determines that moisture is detected when an output from the heat flow sensor changes such as to exceed a threshold.

### CROSS-REFERENCE TO RELATED APPLICATION

This application is based on and claims the benefit of priority from earlier Japanese Patent Application No. 2018-052529 filed on Mar. 20, 2018, the description of which is incorporated herein by reference.

### BACKGROUND

### Technical Field

The present invention relates to an apparatus for detecting moisture, and in particular, to the apparatus which is provided with a heat flow sensor and configured to detect moisture based on a signal outputted from the heat flow sensor.

### Related Art

Conventionally, a moisture detection apparatus that detects water leakage from a pipe or the like is known. For example, a capacitance type and a resistance type are known as such a moisture detection apparatus. The capacitance-type moisture detection apparatus detects moisture based on changes in capacitance, as described in JP-A-2002-357582. The resistance-type moisture detection apparatus detects moisture based on changes in electrical resistance.

However, in the case of the capacitance-type moisture detection apparatus, when a metal component is present in the periphery of a detecting unit, erroneous detection may occur. Therefore, a problem arises in that a setup location of the capacitance-type moisture detection apparatus and a subject on which moisture detection is to be performed are limited. In addition, in the case of the capacitance-type moisture detection apparatus, a problem arises in that the capacitance-type moisture detection apparatus is unsuitable for setup in locations in which static electricity is generated. Furthermore, in the case of the resistance-type moisture detection apparatus, a detecting unit is required to be exposed. Therefore, a problem arises in that the detecting unit may become corroded as a result of contact with moisture.

### SUMMARY

In light of the above-described issues, it is thus desired to provide a moisture detection apparatus that can be set in a location in which a metal component is present nearby or a location in which static electricity may be generated.

A moisture detection apparatus according to an exemplary embodiment includes: a case of which at least a portion serves as a detection surface: a heat flow sensor that is housed in the case and provided such as to be in contact with the detection surface; a heat source that is housed in the case and provided on a side facing the detection surface with the heat flow sensor therebetween; and a determining unit that is housed in the case and determines whether or not moisture is detected based on a detection result from the heat flow sensor.

That is, in the moisture detection apparatus, all of the components required for detection of moisture, including the heat flow sensor, are housed within the case. Consequently, the moisture detection apparatus is unaffected by static electricity. In addition, because the heat flow sensor is not externally exposed, the risk of corrosion can be eliminated.

In addition, in the moisture detection apparatus, the heat flow sensor is arranged such as to be oriented to detect a flow of heat from the heat source towards the detection surface. The heat source generates heat at all times at an amount that enables an output of the heat flow sensor to be in a thermally saturated state in a state in which moisture is not attached to an outer side of the detection surface. The determining unit determines that moisture is detected when the output from the heat flow sensor changes such as to exceed a threshold prescribed in advance.

As a result, because the moisture detection apparatus is configured to detect moisture based on the flow of heat, even should a metal structure or the like be arranged in the periphery, the moisture detection apparatus can detect moisture without being affected by the metal structure or the like. Consequently, the moisture detection apparatus can be set in a location in which a metal component is present in the periphery or a location in which static electricity may be generated.

In a moisture detection apparatus according to a further exemplary embodiment, the detection surface is composed of a metallic material. Consequently, the detection surface has high thermal conductivity. The output of the heat flow sensor more significantly changes when moisture is attached. The risk of erroneous detection can be reduced.

A moisture detection apparatus according to another exemplary embodiment includes a spacer that supports the detection surface such as to be separated from a setup surface, on an outer side of the case. As a result, for example, when the moisture detection apparatus is set on a surface of a metal pipe, because the detection surface is separated from the surface of the pipe, the heat from the heat source can be prevented from being absorbed by the pipe. In addition, the heat source does not need to generate excessive heat.

A moisture detection apparatus according to another exemplary embodiment includes an output commanding unit that is housed in the case and configured to issue a command output of a determination result of the determining unit; and an output unit that is housed in the case and outputs determined results of the determining unit to an external apparatus through wireless communication. Consequently, the moisture detection apparatus can be placed in a sealed state and external wires are not required. The moisture detection apparatus can be set in various locations.

In a moisture detection apparatus according to another exemplary embodiment, both of the determining unit and the output commanding unit are realized by software processing carried out by a control unit provided with a CPU, the control unit being housed in the case.

### BRIEF DESCRIPTION OF THE DRAWINGS

In the accompanying drawings:

FIG. 1 is a diagram schematically showing an electrical configuration of a moisture detection apparatus according to an embodiment;

FIG. 2 is a diagram schematically showing an aspect of an arrangement of the moisture detection apparatus;

FIG. 3 is a diagram schematically showing an aspect of output from a heat flow sensor; and

FIG. 4 is a flowchart outlining a moisture detecting process carried out by a control unit.

### DETAILED DESCRIPTION OF THE PREFERRED EMBODIMENTS

An embodiment of the present invention will hereinafter be described with reference to the drawings.

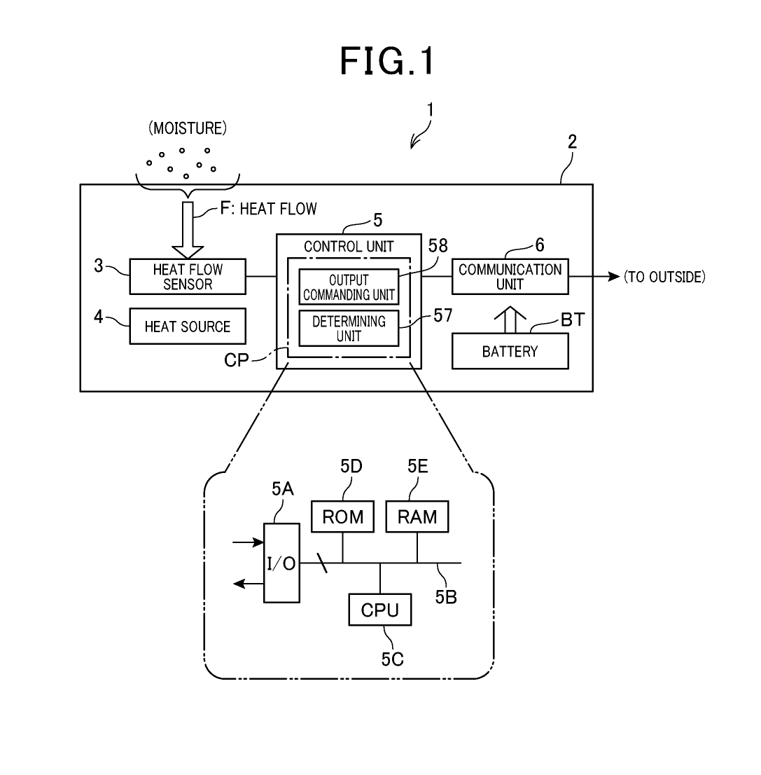

As shown in FIG. 1, in a moisture detection apparatus (i.e., an apparatus for detecting moisture) 1 according to the present embodiment, a heat flow sensor 3, a heat source 4, a control unit 5, a communication unit 6, and the like are housed in a watertight manner in a case 2. According to the present embodiment, setup of the moisture detection apparatus 1 is assumed to be on a surface of a metal pipe through which a liquid, such as water, flows.

According to the present embodiment, the case 2 is formed into a hollow, circular columnar shape having a diameter of approximately several centimeters. The case 2 is composed of a metal material that is resistant to corrosion and has higher thermal conductivity than air. However, for example, a wall surface 2c and an upper surface 2d of the case 2 may be composed of a resin material. That is, the case 2 is merely required to be at least partially provided with a detection surface for detection of moisture. An interior space 2a of the case 2 may be filled with a filling material or the like, as required.

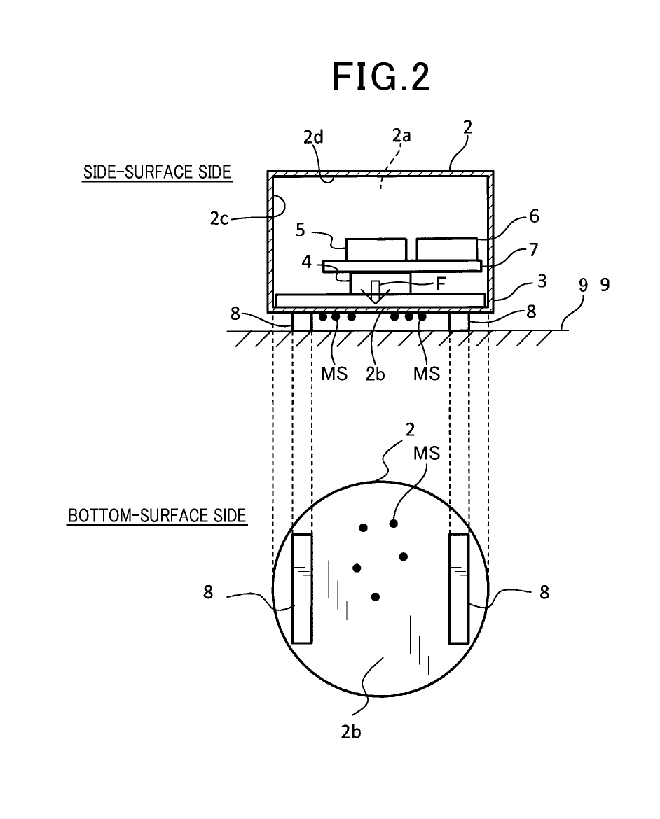

The heat flow sensor 3 is configured to detect, for example, based on Seebeck effect, both an amount of movement of heat and a direction of movement of heat. Practically, the heat flow sensor 3 is configured to energy that passes per unit time or unit area. The heat flow sensor 3 is formed into a film-like shape and is provided such as to be in contact with an inner surface of the case 2, as shown in FIG. 2. According to the present embodiment, the heat flow sensor 3 is in contact with an overall bottom surface 2b that serves as the detection surface. In FIG. 2, hatching is omitted to simplify the description.

The heat flow sensor 3 detects a flow of heat in a thickness direction of the heat flow sensor 3 itself. That is, the heat flow sensor 3 detects the flow of heat, F, from the heat source 4 towards the bottom surface 2b that serves as the detection surface according to the present embodiment (refer to FIG. 2), and outputs an electrical signal corresponding to the detected flow of heat. The heat flow sensor that has a known configuration may be used as the heat flow sensor 3 itself.

The heat source 4 generates heat by energization. The heat source 4 is provided on a side facing the detection surface with the heat flow sensor 3 therebetween. Although described in detail hereafter, the heat source 4 generates heat at all times at an amount that enables the heat flow sensor 3 to be in a thermally saturated state in a state in which moisture is not attached to the outer side of the detection surface. According to the present embodiment, a capacitor is used as the heat source 4. However, for example, an element such as a resistor or a so-called heater may be used as the heat source 4.

In addition, although a single heat source 4 is shown in FIG. 1 and FIG. 2, a plurality of heat sources 4 may be arranged such that the overall heat flow sensor 3 is uniformly thermally saturated. The heat source 4 is provided within the case 2 in a state in which the heat source 4 is mounted on a substrate together with the control unit 5 and the communication unit 6. However, it goes without saying that the heat source 4 may be configured such as not to be mounted on a substrate.

The control unit 5 is provided with a microcomputer CP that controls the moisture detection apparatus 1. The control unit 5 is operated by being supplied electric power from a battery BT that is provided within the case 2 (refer to FIG. 1; in FIG. 2, not shown). In addition, the battery BT also supplies electric power to the heat flow sensor 3, the heat supply 4, and the communication unit 6. The control unit 5 functionally includes a determining unit 57 that determines whether or not moisture is detected and an output commanding unit 58 that commands an output of results by the determining unit 57. The output command unit 58 serves as a driver for the communication unit 6.

Precisely, the microcomputer CP is configured by, as an example, a general-purpose microprocessor provided with an input/output interface 5A connected with an internal bus 5B, a CPU (central processing unit) 5C, ROM (read-only memory: e.g., EPROM or EEPROM) 5D and RAM (random access memory: e.g., DRAM or SRAM) 5E. The internal bus 5B communicably connects the input/output interface 5A, CPU 5C, ROM 5D, and RAM 5E.

The ROM 5D previously stores a program for executing a process for moisture detection. This program is read by the CPU 5C into its work area when being activated and steps described in the program are sequentially executed by the CPU 5C, so that the CPU 5C, that is, the control unit 5 is able to functionally have the determining unit 57 and the output commanding unit 58. The output commanding unit 58 is functionally configured to command the output of determined results to the outside via the commination unit 6. The ROM 5D serves as a non-transient computer readable recording medium in which computer-readable programs for various processes are stored in advance, which include the process for the moisture detection.

In this way, in the present embodiment, the determining unit 57 and the output commanding unit 58 are actualized by software, through a program that is run by the microcomputer CP. Although described in detail hereafter, the determining unit 57 determines that moisture is detected when an output from the heat flow sensor 3 exceeds a threshold that is prescribed in advance.

The communication unit 6 outputs a determination result from the determining unit 57, that is, whether or not moisture is detected, to an external apparatus (not shown) through wireless communication, under the control of the output commanding unit 58, as will be described later. The communication unit 6 serves as an output unit which is under the control of the control unit 5. The communication unit 6 may use a known communication method. However, a low-power-consumption communication method is preferable.

A spacer 8 is provided on the bottom surface 2b of the case 2. The spacer 8 supports the bottom surface 2b of the case 2 such as to be separated from a setup surface 9. According to the present embodiment, the spacer 8 is composed of a resin material that has a lower thermal conductivity than water or metal. Two spacers 8 are arranged such as to be parallel to each other on the bottom surface 2b of the case 2.

For example, the spacer 8 may be formed by protruding portions that are provided in three or four locations that are evenly spaced in a circumferential direction, on the bottom surface 2b of the case 2. Alternatively, the spacer 8 may be formed such that a portion of the wall surface 2c of the case 2 protrudes from the bottom surface 2b.

Next, workings of the configuration described above will be described.

As described above, in the case of the capacitance-type and resistance-type moisture detection apparatuses that have been used in the past, the following problems may arise. That is, the setup location and the subject on which moisture detection is to be performed may be limited. In addition, the moisture detection apparatus may be unsuitable for setup in a location in which static electricity is generated. Furthermore, because a sensor portion is required to be exposed, corrosion may occur.

Therefore, according to the present embodiment, a sensor portion that detects moisture is configured by the heat flow sensor 3. The heat flow sensor 3 is housed within the case 2. Consequently, the moisture detection apparatus 1 can be set near a metal component. In addition, the moisture detection apparatus 1 is unaffected by static electricity. Furthermore, because the heat flow sensor 3 is not exposed, the risk of corrosion is eliminated.

In addition, the heat source 4 is provided on the upper surface 2d of the case 2. The heat flow sensor 3 is kept in a thermally saturated state at all times. A reason for this is as follows: that is, the heat flow sensor 3 detects the flow of heat, and an erroneous detection may occur should the flow of heat be small. Therefore, the flow of heat when moisture is attached to the case 2 is intentionally increased.

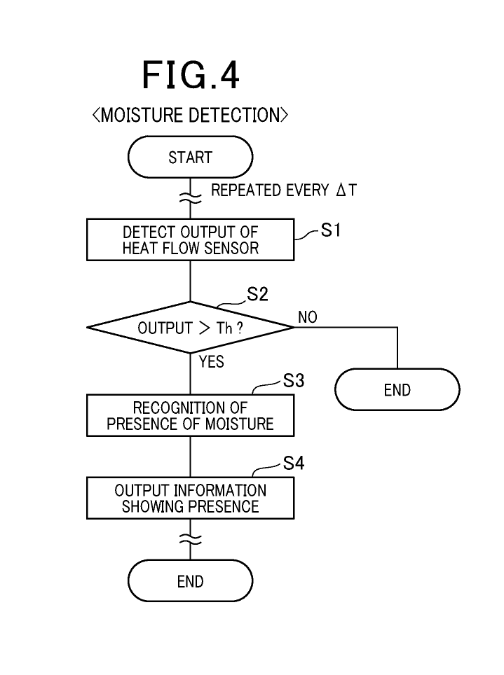

In addition, during execution of a desired main process, the control unit 5, i.e., the CPU 5C executes, at given intervals, a moisture detection process outlined in FIG. 4, such that this moisture detection process is repeated in an interrupted manner of a preset minute time period Δt.

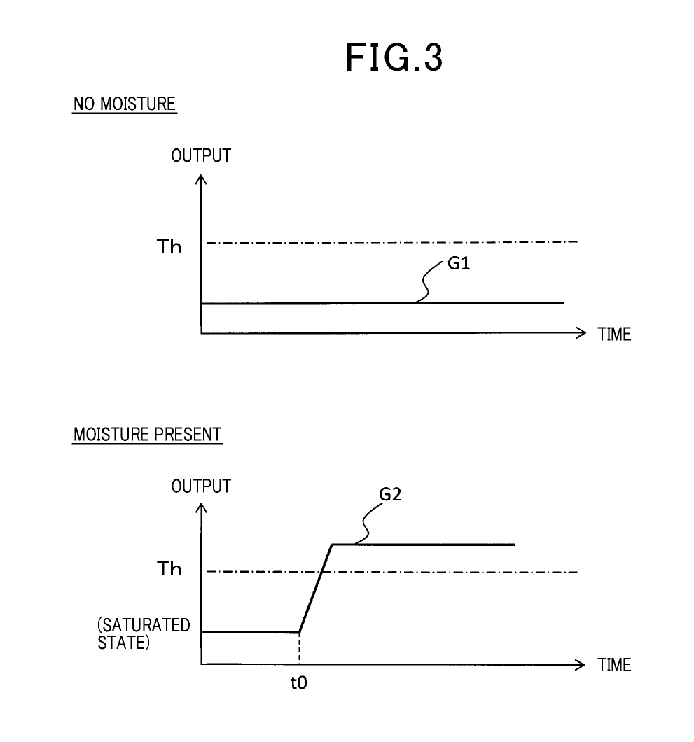

The control unit 5 receives an outputted electrical signal from the heat flow center 3 (step S1) and determines whether or not an amount of heat provided by the received electrical signal is over a predetermined Th threshold for the amount of heat. (step S2: refer to FIG. 3). If it is determined that the detected amount (output) of heat is equal to or less than the threshold Th (NO at step S2), the processing is returned to the main process for the next interruption process.

In contrast, when it is determined that the detected amount (output) of heat is over than the threshold Th (YES at step S2), the processing proceeds to step S3, where the control unit 5 recognizes that there is present moisture on the bottom surface 2b (i.e., the detection surface). Hence, in this case, the control unit 5 issues a command that commands the communication unit 6 to output, for example, an electrical radio signal to the outside to show that moisture has been detected (step S4). In consequence, an external device which receive such signal can take some measures to presence of the moisture.

In this process, the steps S1 to S3 functionally realize the determining unit 57 and the step S4 functionally realizes the output commanding unit 58.

Of course, as a modification, both of the determining unit 57 and the output commanding unit 58 can be configured with the use of electrical circuitry including A/D converter, D/A converter and digital logic circuits.

More practical cases will now be described as below.

Specifically, when moisture is not attached to the bottom surface 2b of the case 2, because the case 2 is separated from the setup surface 9 by the spacers 8, the bottom surface 2b is in contact with ambient air, that is, air. In this case, a slight flow of heat is assumed to be generated as a result of the bottom surface 2b being cooled by the air.

However, as is commonly known, the thermal conductivity of water is relatively low. Therefore, the output of the heat flow sensor 3 when moisture is not attached is thought to be a substantially fixed value, as shown in a graph (G1) for “no moisture” in FIG. 3. More precisely, the output of the heat flow sensor 3 is thought to be a value that slightly varies within a range that is sufficiently below a predetermined threshold (Th).

A reason for this is that the air is not forced over the outer surface of the case 2, such as by a fan, in a manner similar to a so-called air-cooled cooling apparatus. Rather, the air is merely allowed to flow over the outer surface of the case 2 by natural convection. In this case, the determining unit 57 determines that moisture is not attached, that is, moisture is not detected.

In contrast, as shown in a graph (G2) for “moisture present” in FIG. 3, when moisture MS is attached to the outer surface at time (t0) on which air has been present up to this point (refer to FIG. 2), because the thermal conductivity of water is equal to or higher than 20 times the thermal conductivity of air, as is commonly known, in the heat flow sensor 3 that is in the thermally saturated state, the bottom surface 2b is rapidly cooled by the attached moisture MS. The heat flow sensor 3 detects the large flow of heat that flows though the heat flow sensor 3 itself towards the bottom surface 2b side.

As a result, the output of the heat flow sensor 3 shows changes such as that which exceeds the threshold (Th). In this case, as a result of the output of the heat flow sensor 3 changing such as to exceed the threshold (Th) prescribed in advance, the determining unit 57 determines that moisture is attached to the case 2, that is, moisture MS is detected.

The control unit 5, i.e., the CPU 5C executes an output step so that this determination of “attachment of the moisture MS” is then notified to the communication unit 6, whereby this moisture detection information is transmitted to an external device placed outside the moisture detection apparatus 1.

In this manner, the moisture detection apparatus 1 detects the attachment of water, that is, moisture MS on the case 2 using the heat flow sensor 3. Here, the threshold (Th) is set to a value that allows determination of a state in which moisture is attached and a state in which moisture is not attached, through experiments performed in advance.

As a result of the moisture detection apparatus 1 described above, the following effects can be achieved.

The moisture detection apparatus 1 includes the case 2, the heat flow sensor 3, the heat source 4, and the determining unit 57. The detection surface is provided in at least portion of the case 2. The heat flow sensor 3 is housed in the case 2 and provided such as to be in contact with the detection surface. The heat source 4 is housed in the case 2 and provided on the side facing the detection surface with the heat flow sensor 3 therebetween. The determining unit 57 is housed in the case 2 and determines whether or not moisture is detected based on the detection result from the heat flow sensor 3.

That is, in the moisture detection apparatus 1, all of the components required for detection of moisture, including the heat flow sensor 3, are housed within the case 2. Consequently, the moisture detection apparatus 1 is unaffected by static electricity. In addition, because the heat flow sensor 3 is not exposed to the outside, the risk of corrosion can be eliminated.

Furthermore, in the moisture detection apparatus 1, the heat flow sensor 3 is arranged such as to be oriented to detect the flow of heat from the heat source 4 towards the detection surface. The heat source 4 generates heat at all times at an amount that enables the output of the heat flow sensor 3 to be in a thermally saturated state in a state in which moisture is not attached to the outer side of the detection surface. The determining unit 57 determines that moisture is detected when the output of the heat flow sensor 3 changes such as to exceed a threshold prescribed in advance.

As a result, because the moisture detection apparatus 1 is configured to detect moisture based on the flow of heat, even should a metal structure or the like be arranged in the periphery, the moisture detection apparatus 1 can detect moisture without being affected by the metal structure or the like. Consequently, the moisture detection apparatus 1 can be set in a location in which a metal component is present nearby or a location in which static electricity may be generated.

In addition, the case 2 is composed of a metal material that is resistant to corrosion. As a result, the moisture detection apparatus 1 can function as a water leakage detection sensor in cases in which the moisture detection apparatus 1 is set on the surface of a pipe as according to the present embodiment. For example, should the moisture detection apparatus 1 be set on a flow path or inside a pipe through which moisture flows at all times, the moisture detection sensor 1 can function as a water outage detection sensor. Should the moisture detection sensor 1 be set inside a tank, the moisture detection sensor 1 can function as a water level sensor. In this manner, the moisture detection apparatus 1 can be applied to various uses.

Furthermore, in the moisture detection apparatus 1, the bottom surface 2b that serves as the detection surface is composed of a metal material. Consequently, the detection surface has high thermal conductivity. The output of the heat flow sensor 3 more significantly changes when moisture is attached. The risk of erroneous detection can be reduced.

In addition, in the moisture detection apparatus 1, the spacers 8 are provided on the outer side of the case 2. The spacers 8 support the detection surface such as to be separated from the setup surface 9. As a result, for example, when the moisture detection apparatus 1 is set on a surface of a metal pipe, because the detection surface is separated from the surface of the pipe, the heat from the heat source 4 can be prevented from flowing to the pipe. The heat source 4 does not need to excessively generate heat. Consequently, when the moisture detection apparatus 1 is driven by a battery BT as according to the present embodiment, depletion of the battery BT can be suppressed and the like. Further effects can be achieved in this manner.

Moreover, the detection surface is separated from the setup surface 9. Therefore, should merely condensation be present on the surface of the pipe, moisture is not detected. Therefore, the detection of moisture can be more accurately performed. In addition, the overall bottom surface of the moisture detection apparatus 1 serves as the detection surface according to the present embodiment, and the heat flow sensor 3 is in the thermally saturated state. Therefore, only a slight flow of heat is detected when merely a few drops of water flow as a result of condensation. A large flow of heat is detected when moisture of an amount that comes into contact with the overall detection surface is present. Therefore, for example, whether or not the moisture is a water leakage in the pipe can be accurately determined. Further effects regarding actual use can be achieved in this manner.

In addition, the moisture detection apparatus 1 includes the communication unit 6 severing as an output unit. In response to a command from the output commanding unit 58, the communication unit 6 outputs the detection result from the determining unit 57 that is housed in the case 2 to an external apparatus through wireless communication. That is, the communication unit 6 as well as the determining unit 57 and output commanding unit 58, which are functionally realized by the control unit 5, are housed in the case 2. Consequently, the moisture detection apparatus 1 can be placed in a sealed state and external wires are not required. The moisture detection apparatus 1 can be set in various locations.

In addition, the moisture detection apparatus 1 is not limited to the example described above, and may be expanded and modified as appropriate without departing from the spirit of the invention.

For example, according to the embodiment, the case 2 that has a circular columnar shape is given as an example. However, the outer shape of the case 2 may be set as appropriate. For example, the diameter of the case 2 may be changed. Alternatively, the shape of the case 2 may be a rectangular parallelepiped.

In addition, according to the embodiment, the bottom surface 2b serves as the detection surface. However, the wall surface 2c may serve as the detection surface. In this case, the heat flow sensor 3 is arranged on the wall surface 2c. Regarding the upper surface 2d, the upper surface 2d may serve as the detection surface in cases in which the moisture detection apparatus 1 can be set upside down. Alternatively, the heat flow sensor 3 may be arranged on the upper surface 2d.

Furthermore, according to the embodiment, the overall bottom surface 2b serves as the detection surface. However, a portion of the bottom surface 2b may serve as the detection surface. In this case, the portion of the bottom surface 2b that serves as the detection surface may be composed of a metal material. This also applies to when the wall surface 2c or the upper surface 2d serves as the detection surface. Moreover, according to the embodiment, the detection surface is composed of a metal material. However, the detection surface may also be composed of a resin material or the like.

### PARTIAL EXPLANATION OF REFERENCE NUMBERS

1: moisture detection apparatus (apparatus for detecting moisture)
2: case
2b: bottom surface (detection surface)
2c: wall surface (detection surface)
2d: upper surface (detection surface)
3: heat flow sensor
4: heat source
5: control unit (determining unit, output unit)
57: determining unit
58: output commanding unit
6: communication unit (output unit)
8: spacer
9: setup surface

What is claimed is:

1. A moisture detection apparatus, comprising:
a case of which at least a portion serves as a detection surface:
a heat flow sensor that is housed in the case and provided such as to be in contact with the detection surface;
a heat source that is housed in the case and provided on a side facing the detection surface with the heat flow sensor therebetween; and
a determining unit that is housed in the case and configured to determine whether or not moisture is detected based on a detection result from the heat flow sensor, wherein
the heat flow sensor is arranged such as to be oriented to detect a flow of heat from the heat source towards the detection surface,
the heat source generates heat at all times at an amount that enables the heat flow sensor to be in a thermally saturated state in a state in which moisture is not attached to an outer side of the detection surface, and
the determining unit is configured to determine that moisture is detected when an output from the heat flow sensor changes such as to exceed a threshold prescribed in advance.

2. The moisture detection apparatus according to claim 1, wherein
the detection surface is composed of a metallic material.

3. The moisture detection apparatus according to claim 1, comprising:
a spacer that supports the detection surface such as to be separated from a setup surface, on an outer side of the case.

4. The moisture detection apparatus according to claim 1, comprising:
an output commanding unit that is housed in the case and configured to issue a command output of a determination result of the determining unit; and
an output unit that is housed in the case and configured to output the determination result of the determining unit to an external apparatus through wireless communication, in response to the issued command.

5. The moisture detection apparatus according to claim 4, wherein both of the determining unit and the output commanding unit are realized by software processing carried out by a control unit provided with a CPU, the control unit being housed in the case.

6. The moisture detection apparatus according to claim 2, comprising:
a spacer that supports the detection surface such as to be separated from a setup surface, on an outer side of the case.

7. The moisture detection apparatus according to claim 6, comprising:
an output commanding unit that is housed in the case and configured to issue a command output of a determination result of the determining unit; and
an output unit that is housed in the case and configured to output the determination result of the determining unit to an external apparatus through wireless communication, in response to the issued command.

8. The moisture detection apparatus according to claim 7, wherein both of the determining unit and the output commanding unit are realized by software processing carried out by a control unit provided with a CPU, the control unit being housed in the case.
